(19) United States
(12) Patent Application Publication
(10) Pub. No.: US 2015/0326060 A1
(43) Pub. Date: Nov. 12, 2015

(54) Bulk Wireless Charger

(71) Applicant: Chris M. Young, Round Rock, TX (US)

(72) Inventor: Chris M. Young, Round Rock, TX (US)

(21) Appl. No.: 14/707,613

(22) Filed: May 8, 2015

Related U.S. Application Data
(60) Provisional application No. 61/990,394, filed on May 8, 2014.

(51) Int. Cl. H02J 7/02; H02J 7/00

(52) U.S. Cl. CPC H02J 7/025; H02J 7/0042; H02J 7/0047; H02J 7/007; H02J 7/0021; H02J 2007/0049

(57) ABSTRACT

An improved bulk wireless charger station may be constructed of a number of individual wireless charger modules. Each module may include an embedded wireless charger transmitter with the capability of wirelessly charging a device inserted into the module. The device may have the capability of being wirelessly charged via a wireless charging receiver in communication with the wireless charger transmitter. Charging the device may include charging a battery or other electrical storage element within the device, which, once charged, may power the device during use. The charger modules may be stackable horizontally and/or vertically to form the charger station. Each charger module may also include a power interface for receiving power from either a power base or other charger modules, and/or a communication interface for communicating with other charger modules and/or control station(s). The embedded wireless charger transmitter may be a transmitter coil controlled through a power conversion/control board.

### PRIORITY CLAIM

This application claims benefit of priority of U.S. Provisional Patent Application Ser. No. 61/990,394 titled “Bulk Wireless Charger”, filed on May 8, 2014, which is hereby incorporated by reference as though fully and completely set forth herein.

### FIELD OF THE INVENTION

The present invention relates to the field of electrical charging devices, and more particularly to the design of an improved bulk wireless charger.

### DESCRIPTION OF THE RELATED ART

Portable smart computing devices such as smart phones, tablets and ultra-notebook computers are typically required to be lightweight, yet they are still expected to satisfy significant computing demands which can limit battery life. These devices have been joined in recent years by wearable devices such as smart glasses and smart watches. Conventional charging of the batteries in such portable (or wearable) computing devices and mobile devices is typically accomplished through the use of an adapter with a charging cable attached via an appropriate connector to the device to be charged. In certain settings, there is a need to operate a larger number of portable devices, which necessitates bulk charging these devices in order for at least a minimum number of the devices to be ready for operation as required. One example is the ever more frequent use of digital tablets (e.g. iPad™ or Android™ tablets) in restaurants by patrons to place orders, play games while awaiting service, and/or fill out surveys. In situations where bulk charging of multiple devices is required, connecting charging cables to the devices can result in significant time and effort. In addition, the connector used for connecting the charger to the device can itself be subject to reliability issues with its fragile pins and repetitively flexed cable.

In order to simplify bulk charging and obviate the need for cables, newer charging technologies make use of electromagnetic charging techniques, whereby instead of physical cables a magnetic field is used to couple the charger to the device being charged. This not only eliminates the need for a connector or cable, it also eliminates the effort and time required to make the physical connections. With electromagnetic charging technology, the connection only requires a near proximity of the receiving apparatus in the charging device (i.e. the device to be charged) to the transmitting apparatus in the charger device (i.e. the adapter or charger that is used to charge the computing device). There are no mechanical connections or cables that are subject to wear and tear. Therefore, in the long term, magnetic and/or inductive charging techniques presents a much more reliable method for the bulk charging of various portable and/or wearable computing devices, or any other batter operated devices that may require electrical charging. The current state of the art for inductive chargers uses a flat surface where the device to be charged is placed flat on the surface as illustrated in FIG. 1, showing a wireless multi-power transmission device 10 for transmitting a power signal to a wireless power transmission device 30 in a wireless manner. The wireless multi-power transmission device 10 includes a wireless charger case 11 which houses a full-bridge resonant converter and a central controller mounted inside to transmit a power signal to the wireless power transmission device 30 in a wireless manner. The wireless charger case 11 has a wireless charger table 12 on top of case 11, with multiple charger blocks 14, each of which includes a primary charging core. The wireless charger case 11 has a power on/off switch 151, an input panel 152 for inputting a signal, and a LCD (liquid crystal display) panel 153 and an indicator LED 154 that displays a charging state of the wireless charger table 12. As seen in FIG. 1, multiple devices require that the area of the flat surface of charger table 12 grow in direct proportion to the number of devices that are placed on the surface. Thus, for example, a bulk charger using the flat surface approach to charging five tablets will have a surface area roughly five times larger than the surface area required to charge a single device. Such a large area is inconvenient for many locations and does not scale favorably.

Other corresponding issues related to the prior art will become apparent to one skilled in the art after comparing such prior art with the present invention as described herein.

### SUMMARY OF THE INVENTION

Various embodiment of an improved bulk wireless charger station facilitate a compact arrangement for charging multiple electronic devices, such as portable computer tablets for example, by reorienting the charging devices to be situated in parallel to each other as opposed to being situated in a coplanar manner. Accordingly, various embodiments of a wireless charger module may include an enclosure with a slot having at least one open end, and which may hold a device to be charged. The enclosure may further include an embedded wireless charger transmitter that wirelessly interfaces with a corresponding wireless charging receiver and inductively charges the device via the corresponding wireless charging receiver. In some embodiments, the wireless charger transmitter is a transmitter coil, which may consist of coils of wire or spiral traces on a printed circuit board. Furthermore, the module may be stackable, and the enclosure may therefore have a shape conducive for combining with other wireless charger modules to form a single stable bulk wireless charger station.

The module also include one or more power interface(s) that interface with a power source providing electrical power to the module through the power interface(s). The module may further include one or more first wireless charger component(s) providing electrical power to the module through the power interface(s). In some embodiments, the module includes one or more second wireless charger component(s), with the module providing power to the second wireless charger component(s) through power interface(s). The module may also include a status indicator indicating when the device is charging, when the device has completed charging, and/or that a charger malfunction has occurred. In addition, the module may include power conversion and control circuitry that controls the wireless charger transmitter. In one set of embodiments the module includes a fan on the back panel of the enclosure disposed at a closed end of the slot, for convectively removing heat from the slot and the device.

The wireless charger transmitter may be shielded such that the wireless charger transmitter does not interface with wireless charging receivers situated outside the slot. In some embodiments the module also includes circuitry that facilitates high frequency communications with the device. The communications may include information regarding the charging status of the device, information about the device such as device model, firmware revision, and/or device characteristics, and/or instructions to upgrade software in the device while the device is situated in the slot. The module may further include circuitry for facilitating high frequency communications with a host computer and/or a supervisor monitoring the device to be charged (i.e. the charging device). In addition, alignment stops in the slot may serve to align the device relative to the wireless charger transmitter when the device is inserted into the slot. The wireless charging receiver may be integrated directly into the device, or it may be integrated into a component that electrically connects to the device.

Various other embodiments of a bulk wireless charger station may include a plurality of slots, with each respective slot having at least one open end and capable of holding a respective device to be charged. The station may also include a plurality of fins, with each respective slot enclosed by a respective pair of fins, and each respective fin of at least a subset of the fins including a respective embedded wireless charger transmitter. The respective embedded wireless charger transmitter may wirelessly interface with a respective corresponding wireless charging receiver, and inductively charge, via the respective corresponding wireless charging receiver, the respective device held in the respective slot that is at least partially formed by the respective fin that includes the respective embedded wireless charger transmitter. The station may have a base to which the fins are attached to form the slots, with the base also providing power to each respective embedded wireless charger transmitter in each respective fin. The base may further include a respective charge indicator corresponding to each respective slot, with the respective charge indicator providing an indication of the charging status of the respective device held in the respective slot.

In one set of embodiments, the station may also have a top plate, with the fins also attached to the top plate which provides a horizontal cover over the slots. The slots may be arranged in one of two ways. In a vertical arrangement, a respective slot is either above or underneath a neighboring respective slot. In a horizontal arrangement, a respective slot is either to the left or to the right of a neighboring respective slot. The respective embedded wireless charger transmitter in a respective fin may include an inductive coil that consists of a wire coil, or it may include an inductive coil consisting of spiral traces on a printed circuit board. In one set of embodiments, the station may include communications circuitry that facilitates high frequency communications with the respective device to be charged, a host computer, and/or a supervisor monitoring the respective device. The communications may include information regarding the charging status of the respective device, and/or information about the respective device such as device model, firmware revision, and/or device characteristics. The communications may also include instructions to upgrade software in the respective device while the device is situated in the respective slot.

Other aspects of the present invention will become apparent with reference to the drawings and detailed description of the drawings that follow.

### BRIEF DESCRIPTION OF THE DRAWINGS

A better understanding of the present invention can be obtained when the following detailed description of the preferred embodiment is considered in conjunction with the following drawings, in which:

FIG. 1 shows an illustration of a bulk wireless charger system according to prior art;

FIG. 2 shows an illustration of stackable wireless charger station modules according to one set of embodiments;

FIG. 3 shows an illustration of stackable wireless charger station modules according to another set of embodiments;

FIG. 4 shows a more detailed illustration of one embodiment of a stackable wireless charger station module; and

FIG. 5 shows an illustration of one embodiment of a bulk wireless charger system incorporating stackable wireless charger station modules.

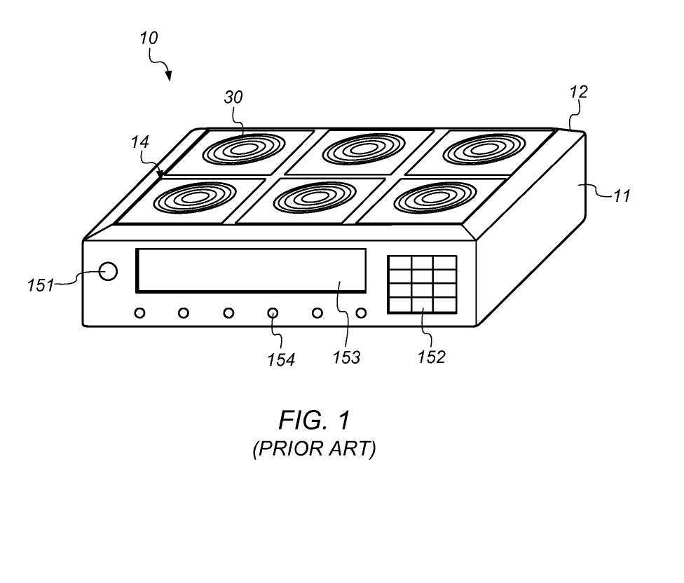

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

As an improvement upon existing bulk wireless charging methods and systems, various embodiments are disclosed herein of wireless bulk charger stations in which the devices to be charged (i.e. the charging devices) are reoriented such that the charging devices are parallel to each other as opposed to being disposed in a coplanar manner. Such arrangement permits multiple devices to be simultaneously charged in a wireless manner without requiring ever increasing surface area for the wireless charging system.

In various embodiments, a bulk wireless charger station or charger system may allow the charging devices to be stacked on top of each other with the main surfaces of the charging devices parallel to each other, or the charging devices placed side by side with their main surfaces aligned vertically and in parallel. Each device to be charged (i.e. each charging device) may have an embedded inductive charger receiving apparatus enabling the device to be charged. Furthermore, each device may be physically separated from each other device by a mechanical barrier or fin of the bulk wireless charger station/system, each of which may have its own inductive charger transmitting apparatus. By stacking the devices horizontally and/or vertically, significant space savings may be achieved with respect to bulk wireless charger stations/system available in the current state of the art. The barriers or fins may be attached to a base, which may include the remaining portions of the charger circuitry.

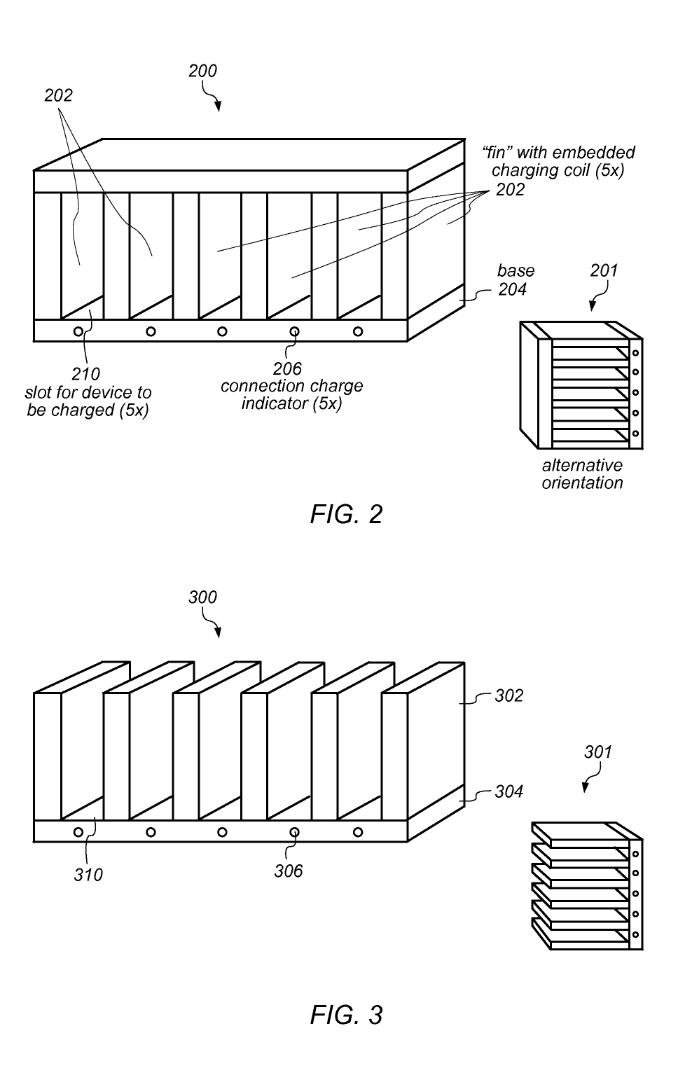

One embodiment of a bulk wireless charger station 200 is illustrated in FIG. 2. As mentioned above, each charging device (not shown) may have an embedded inductive charging receiving apparatus enabling the device to be charged. To physically separate each device from each other device, charger apparatus 200 may be constructed with mechanical barrier(s) or fin(s) 202, each of which may have its own inductive charger transmitting apparatus, or charger coil. By stacking the devices horizontally, as illustrated by system configuration 201, or vertically, as illustrated by system configuration 200, significant space savings may be achieved. The barriers or fins 202 may be attached to a base 204, which may include the remaining portions of the charger circuitry. The arrangement in FIG. 2 shows slots 240 into which the charging devices may be inserted, with a connection charge indicator 206 (e.g. an LED light) underneath each slot to provide an indication of whether the device is charging and/or finished charging. As used herein, slots 240 are also referred to as cavity 240, which may house a charging device. The slot/cavity “housing” the charging device indicates that the charging device may be safely placed inside the cavity/slot for storing and/or wirelessly charging the device.

External power may be supplied to the charger station 200 (and 201) using a single cable or connector (not shown). The power supply may be either a DC (direct current) supply or AC (alternating current) supply. Additional cables and/or connectors may be used for redundant supply or supplies. The base 204 may be used to receive and distribute the power to the transmitting fins 202. The distributed power may be converted and conditioned as appropriate by circuitry located in the base 204 or otherwise disposed in the system. Additional circuitry may also be included for performing various tasks or functions as desired. For example, circuitry may be included to perform diagnostics for power status and/or quality, temperature sensing/reporting, reporting on the devices or the number of devices being connected, etc. The base 204 may also include functionality not related to charging such as router functionality, data storage, and/or server functionality, allowing bulk charger station 200 (and/or 201) to communicate with various other devices, store statistical information related to the charging devices, and the like.

As illustrated in FIG. 2, the mechanical assembly of charger station 200 includes a side, or top portion, opposite the base 204. In other embodiments, as illustrated in FIG. 3, charger station 300 may follow an open design with only the base 304. A station 301 with alternative (vertical) orientation is also shown, similar to vertically disposed station 201 shown in FIG. 2. For any one or more of stations 200, 201, 300, and 301, a solid backing may be provided on the back end of the charger slots to prevent the devices from passing completely through the charger slot. Station 200 (and 301) may also include the charger slot(s) 310 and charging indicator(s) 306, with fin(s) 302 housing embedded charger coils. Features may also be incorporated to align the charging devices so that the system is automatically aligned. Charger transmitting coils may be aligned on the same axis or may be offset to reduce interaction or interference.

The charger and elements of the charger (within fins 202/302 and/or within base 204/304) may be constructed with materials which either focus or shield the magnetic fields to improve performance. Certain non-magnetic or essentially non-conducting materials may also be used such that they do not interfere with the magnetic fields. While the embodiments of charger stations 200, 201, 300, and 301 are shown featuring five slots for devices to be charged, various alternate embodiments may be scaled and stacked for any number of fewer or additional devices. Due to the highly modular design, various embodiments may range from a single slot for a single charging device to multiple slots for multiple charging devices, one device per charger slot, as desired.

In one set of embodiments, the charger stations may include features to automatically detect the presence of a device to be charged using optical or near field communications. Visual or auditory indicators may also be included on the base, sides, or fins to indicate that a device or devices are present, connected, charging, and/or to provide a status of charge (some of which are illustrated in FIGS. 2 and 3 as mentioned above). If cooling is required, a fan or fans may be added to convectively remove heat. Alternately, the mechanical structure (the base and/or entire housing) may be designed to dissipate the heat by conduction and/or passive convection cooling.

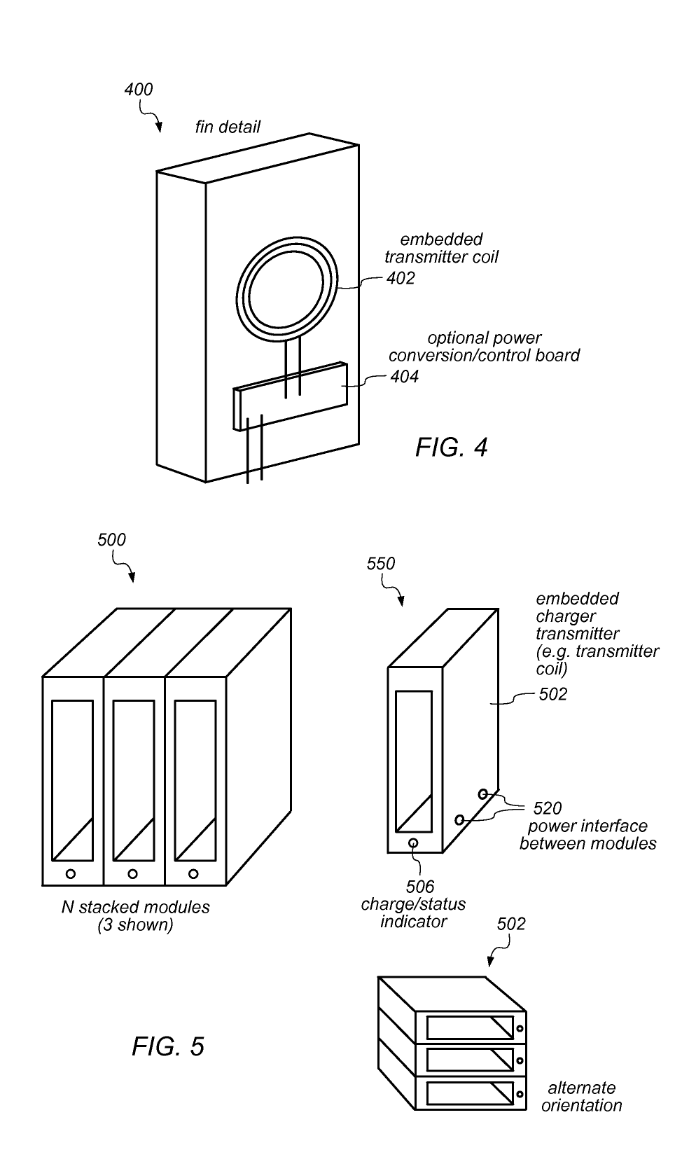

As also previously mentioned, the fins may contain the charger transmitting coils for inductively charging the devices inserted into the charger slot. A more detailed embodiment of a fin 400 is illustrated in FIG. 4. The embedded coils 402 may be shielded such that the device on one specific side of the coil/fin is charged, or no shielding may be used to allow devices to be charged on either side of the coil/fin, thereby reducing the number of fins that may be required to incorporate coils. In one set of embodiments, the embedded coils 402 may be composed of coils of wire. In another set of embodiments, the embedded coils 402 may be composed of spiral traces on a printed circuit board. A printed circuit board may also be embedded in fin 400 to include the charging circuitry which powers and controls the transmitting coils 402. Circuitry on this optional power conversion/control board 404 may also implement functionality for high frequency communication with the device being charged. The communication may include the status of the charge/charging, or even information about the device such as device model, firmware revision, etc. This high frequency communication may also be used to upgrade the software in the device while the device is situated in the charger station. Overall, optional circuitry 404 may be implemented on a printed circuit board or it may be embedded/incorporated into fin 400 as a system on a chip (SOC) coupled to embedded transmitter coil 402, or it may be implemented on a field programmable gate array (FPGA), or as a combination of hardware and software controlling operation of embedded coil 402, as well as implementing additional functionality as described above.

In some embodiments, the charger station (e.g. 200, 201, 300, and/or 301) may also contain circuitry to communicate charging information and/or device data via one or more of several communication methods, e.g. via WiFi, BLUETOOTH®, or Ethernet connectivity, as data streams, text messages, email, data packets, etc. to a host (e.g. a host computer or central control station), to a supervisor, and/or to an operator. The charging receiving coil for the device to be charged may be integrated into the device itself or it may be integrated into a sleeve, wallet, or case which connects the inductive charging receiving apparatus to the charging device through any one or more connecting means such as a power connector, USB connector or some other suitable connector. The case that includes the charging receiving coil may provide an antibacterial surface for the device as well as seal off any exposed connectors to prevent biological or chemical contamination, and may include all of the power conversion and control circuitry for the inductive charging receiver. Alternatively, the power conversion and control circuitry may be located inside the device that is to be charged.

Some embodiments of the charger station may be placed on a horizontal surface such as a desk or table or it may be mounted on a vertical surface such as a wall or cabinet. Other aesthetic and/or architectural features may be added to various embodiments of the charger station to accent the décor of a room. In one set of embodiments, the surfaces of the charger station may be rounded and shaped of various materials and designs, which allow for the same basic charging functions while enhancing the visual presentation of the charging system. In some embodiments, the charger station may also include features that allow passive automatic alignment of the device to be charged relative to the location of the transmitting coil such that there is no need for a large active transmission area or need to manually adjust the location. In such embodiments, the device to be charged (i.e. the charging device) may simply slide into the charging slot and against the alignment stops.

In various embodiments, a bulk inductive charger may be constructed of charger modules, with each charger module modularized as illustrated in FIG. 5. It should be noted that each charger module 550 shown in FIG. 5 may also be used individually if desired, as a single charger module, and need not be combined with other similar modules. However, the shape of the enclosure of charger module 550 may be designed to be conducive for combining with other charger modules 550 as illustrated in FIG. 5. For example, bulk wireless charger system/station 500, as shown, includes three charger station modules 550. While FIG. 5 illustrates a charger module 550 having a rectangular, or “brick” shape with a corresponding cavity (or housing) to receive the device to be charged, in alternate embodiments, the shape of the charger module 550 may be different with a corresponding associated cavity (housing), while still being fully stackable with other charger modules. That is, the shape of charger module 550 may be designed to “interlock” or even complementarily adhere to or combine with other charger modules to form a single stable structure (such as 500 and/or 502 for the “brick” shape charger module), with each slot/cavity capable of housing a charging device. Overall, charger modules disclosed herein are said to have an enclosure capable of adhering to or combining with the enclosure of another charger module, when the charger modules seamlessly combine into a single stable structure operating as a bulk wireless charger station in which multiple devices may be simultaneously charged wirelessly without requiring the charging devices to be disposed in a single horizontal plane. That is, a stable, multi-slot/multi-cavity bulk wireless charger system may be achieved even when using charger modules of shapes different from those shown, so long as the charger modules combine with each other to form a stable multi-cavity bulk wireless charger station. For example, if a first side of the charger module enclosure is concave, a second, opposite side of the charger module enclosure may be convex (complementary to the first side), permitting multiple charger modules to be stably stacked (concave side of one module adhering to/combining with the convex side of another module). Furthermore, the power interface 520 may also be designed to provide structural connectivity in addition to electrical/power interfacing, to more stably combine the charger modules.

Each module 550 may contain an embedded inductive charger transmitter 502, an optional status indicator 506, optional power conditioning and communication circuitry, and a method for conducting DC or AC power from module to module. Each module 550 also may have an independent input port for external power (not shown). Alternately, a “base” module with an input power port may be provided, and each module 550 may receive its conducted power through the module to module power interface 520. As shown in FIG. 5, any number (N) of modules may be stacked (the embodiment shown in FIG. 5 illustrates three modules being stacked), and the modules may also be stacked vertically as exemplified by bulk wireless charger station 502. Other functional modules with the same (or similar) input power interface may be added to provide functions other than wireless charging. For example, additional modules may include data storage, server or computing functions, routing and/or WLAN capability, status indicators, control functions such as on/off, etc. In addition to the input power interface 520, modules 550 may include a data communication interface to interface with other modules to exchange information (e.g. status information), data, and/or control information, among others, between modules. The data interface may or may not interface with the wireless communications associated with the embedded wireless charger.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A wireless charger module, the module comprising:
an enclosure comprising a slot having at least one open end and configured to hold a device to be charged; and
an embedded wireless charger transmitter configured to wirelessly interface with a corresponding wireless charging receiver and inductively charge the device via the corresponding wireless charging receiver.

2. The module of claim 1, wherein the enclosure has a shape conducive for combining with other wireless charger modules to form a single stable bulk wireless charger station.

3. The module of claim 2, wherein the wireless charger transmitter comprises a transmitter coil that comprises one of:
coils of wire; or
spiral traces on a printed circuit board.

4. The module of claim 1, further comprising:
one or more power interfaces configured to interface with one or more of the following:
a power source providing electrical power to the module through the one or more power interfaces;
one or more first wireless charger components providing electrical power to the module through the one or more power interfaces; or
one or more second wireless charger components, wherein the module is configured to provide power to the one or more second wireless charger components through the one or more power interfaces.

5. The module of claim 1, further comprising a status indicator indicating one or more of the following:
when the device is charging;
when the device has completed charging; or
a charger malfunction has occurred.

6. The module of claim 1, further comprising power conversion and control circuitry configured to control the wireless charger transmitter.

7. The module of claim 1, further comprising a fan configured on a back panel of the enclosure disposed at a closed end of the slot, wherein the fan is configured to convectively remove heat from the slot and the device.

8. The module of claim 1, wherein the wireless charger transmitter is shielded such that the wireless charger transmitter does not interface with wireless charging receivers situated outside the slot.

9. The module of claim 1, further comprising circuitry configured to facilitate high frequency communication with the device.

10. The module of claim 9, wherein the communication comprises one or more of the following:
charging status of the device;
information about the device, the information comprising one or more of device model, firmware revision, or device characteristics; or
instructions to upgrade software in the device while the device is situated in the slot.

11. The module of claim 1, further comprising circuitry configured to facilitate high frequency communication with one or more of the following:
a host computer; or
a supervisor monitoring the device.

12. The module of claim 1, further comprising alignment stops configured in the slot to align the device relative to the wireless charger transmitter when the device is inserted into the slot.

13. The module of claim 1, wherein the wireless charging receiver is integrated into one of:
the device; or
a component configured to electrically connect to the device.

14. A bulk wireless charger station, the station comprising:
a plurality of slots, wherein each respective slot of the plurality of slots comprises at least one open end and is configured to hold a respective device to be charged;
a plurality of fins, wherein each respective slot is enclosed by a respective pair of fins of the plurality of fins, and wherein each respective fin of at least a subset of the plurality of fins comprises a respective embedded wireless charger transmitter, wherein the respective embedded wireless charger transmitter is configured to:
wirelessly interface with a respective corresponding wireless charging receiver; and
inductively charge, via the respective corresponding wireless charging receiver, the respective device held in the respective slot that is at least partially formed by the respective fin that comprises the respective embedded wireless charger transmitter.

15. The station of claim 14, further comprising a base to which the plurality of fins are attached to form the plurality of slots, wherein the base is configured to provide power to each respective embedded wireless charger transmitter comprised in each respective fin of the at least a subset of the plurality of fins.

16. The station of claim 15, wherein the base comprises a respective charge indicator corresponding to each respective slot, wherein the respective charge indicator provides an indication of the charging status of the respective device held in the respective slot.

17. The station of claim 15, further comprising a top plate, wherein the plurality of fins are also attached to the top plate, wherein the top plate provides a horizontal cover over the plurality of slots.

18. The station of claim 14, wherein the plurality of slots are arranged according to one of:
a vertical arrangement in which a respective slot is either above or underneath a neighboring respective slot; or
a horizontal arrangement in which a respective slot is either to the left or to the right of a neighboring respective slot.

19. The station of claim 14, wherein the respective embedded wireless charger transmitter comprises one of:
an inductive coil comprising a wire coil; or
an inductive coil comprising spiral traces on a printed circuit board.

20. The station of claim 14, further comprising communications circuitry configured to facilitate high frequency communications with at least one of the following:
the respective device to be charged;
a host computer; or
a supervisor monitoring the respective device;
wherein the communications comprise at least one of the following:
charging status of the respective device;
information about the respective device, the information comprising one or more of device model, firmware revision, or device characteristics; or
instructions to upgrade software in the respective device while the device is situated in the respective slot.
